(19) United States
(12) Patent Application Publication
(10) Pub. No.: US 2025/0035312 A1
(43) Pub. Date: Jan. 30, 2025

(54) HUMIDITY DETECTION-BASED PELLET GRILL CONTROL METHOD AND FEEDING SYSTEM OF PELLET GRILL

(71) Applicant: NINGBO AGSUN PRODUCTS,INC., CIXI (CN)

(72) Inventors: Leiwen Lu, CIXI (CN); Yuchen Guo, CIXI (CN); Linqiang Wang, CIXI (CN); Binhang Sun, CIXI (CN); Jinsheng Wu, CIXI (CN); Xuefei Mao, CIXI (CN); Xianghua Liu, CIXI (CN)

(21) Appl. No.: 18/914,158

(22) Filed: Oct. 12, 2024

(30) Foreign Application Priority Data
Jun. 12, 2024 (CN) 202410752842.6

(51) Int. Cl. F24B 1/02; F23B 40/00; F23K 3/00; F24B 13/04; G01K 3/00; G01N 27/04

(52) U.S. Cl. CPC F24B 1/024; F23B 40/00; F23K 3/00; F24B 13/04; G01K 3/005; G01N 27/048; F23K 2203/202

(57) ABSTRACT

The present invention relates to a humidity detection-based pellet grill control method and a feeding system of a pellet grill, where the pellet grill is energized so that the feeding system thereof and a humidity sensor on the feeding system are in an energized state; and the humidity sensor is used to continuously monitor humidity of a fuel conveying channel of the feeding system in which a pellet fuel has been stored, so that a controller determines humidity level of a space environment or the pellet fuel in the fuel conveying channel. This can prevent the fuel that has become powdered due to moisture from drying into hard lumps again in the fuel conveying channel which can result in blockage of a screw conveyor, thus protecting the feeding system and reducing maintenance costs.

### TECHNICAL FIELD

The present invention relates to the technical field of pellet fuel feed control of a pellet grill, and in particular, relates to a humidity detection-based pellet grill control method and a feeding system of a pellet grill.

### BACKGROUND

Pellet grills are generally used for cooking food, such as ARRANGEMENT OF COMPONENTS WITHIN A COOKING DEVICE disclosed in U.S. Patent Publication No. US20230309743A1, which consists of a combustion chamber, a cooking structure located above the combustion chamber and a pellet fuel feeding system connected with the combustion chamber. In use, the feeding system conveys a pellet fuel into the combustion chamber for combustion to grill the food on the cooking structure. However, the feeding system is composed of a fuel conveying channel and a screw provided in the fuel conveying channel, the pellet grill is generally used outdoors, and high ambient humidity as well as weather factors such as heavy fog and rain may easily result in wetting of residual pellet fuel in the feeding system of the pellet grill, and therefore the feeding system of the existing pellet grill is prone to the following defects:

1. when the pellet grill with the above conditions is not used for a long time, the pellet fuel expands and binds when exposed to moisture, and forms hard lumps after re-drying, resulting in blockage of the screw conveyor of the feeding system and affecting the use of the screw convey. Moreover, maintenance cost of the screw conveyor of the feeding system is very high after the screw conveyor is blocked, requiring a lot of after-sale labor costs.

2. Introduction of moist pellets into the combustion chamber at the time of ignition can lead to ignition failure, affecting efficiency of the pellet grill.

Therefore, due to the above defects, there is an urgent need for a pellet grill structure capable of solving the above technical problems.

### SUMMARY

The present invention relates to a humidity detection-based pellet grill control method and a feeding system of a pellet grill to solve the above technical problems.

The humidity detection-based pellet grill control method according to the present invention includes the following steps:
S1. energizing a pellet grill so that a feeding system thereof and a humidity sensor provided on the feeding system are in an energized state; and
S2. using the humidity sensor to continuously monitor humidity of a fuel conveying channel of the feeding system in which a pellet fuel has been stored, so that a controller determines humidity level of a space environment or the pellet fuel in the fuel conveying channel;
if the space environment or the pellet fuel in the fuel conveying channel is determined to have high humidity, controlling, by the controller of the pellet grill, the feeding system to enter a rejection mode of returning the pellet fuel to a feed port of the feeding system, or the pellet grill to enter a drying and ignition mode or the pellet grill to enter an anti-extinction mode; and
if the space environment or the pellet fuel in the fuel conveying channel is determined to have low humidity, controlling, by the controller, the feeding system of the pellet grill to enter a feedable mode.

As another aspect, a feeding system of a pellet grill includes:
a screw conveyor including a fuel conveying channel, a screw located in the fuel conveying channel and a rotary drive device for driving the screw to rotate, where a discharge port of the fuel conveying channel is connected with a feed opening of a combustion chamber;
a humidity sensor provided on a wall body of the fuel conveying channel; and
a controller, where the rotary drive device and the humidity sensor are respectively connected with and controlled by the controller.

The humidity detection-based pellet grill control method and the feeding system of the pellet grill according to the present invention have the following beneficial effects:

1. The humidity sensor arranged on the fuel conveying channel detects the humidity in the fuel conveying channel, and when the controller determines high humidity according to the humidity value fed back by the humidity sensor, the controller controls the feeding system to perform rejection to return the moist pellet fuel to the feed port of the fuel conveying channel so as to prevent the fuel that has become powdered due to moisture from drying into hard lumps again in the fuel conveying channel which can result in blockage of a screw conveyor, thus protecting the feeding system and reducing maintenance costs.

2. When the pellet grill is used outdoors for cooking food, the controller recognizes a high ambient humidity currently in the fuel conveying channel and high humidity of the pellet fuel when the pellet grill is energized, therefore the drying and ignition mode is started while feeding, so that the moist fuel conveyed into the combustion chamber is dried by the ignition rod, and the ignition is completed by continuous operation of the ignition rod and by means of the fan, thus solving the technical problem of difficult and impossible ignition of the moist pellet fuel.

### BRIEF DESCRIPTION OF THE DRAWINGS

FIG. 1 is a first overall structural schematic diagram of a pellet grill;

FIG. 2 is a second overall structural schematic diagram of the pellet grill;

FIG. 3 is a first structural schematic diagram of a grill body in which a feeding system is mounted in the pellet grill;

FIG. 4 is a second structural schematic diagram of a grill body in which a feeding system is mounted in the pellet grill;

FIG. 5 is a third structural schematic diagram of a grill body in which a feeding system is mounted in the pellet grill;

FIG. 6 is a fourth structural schematic diagram of a grill body in which a feeding system is mounted in the pellet grill;

FIG. 7 is a fifth structural schematic diagram of a grill body in which a feeding system is mounted in the pellet grill;

FIG. 8 is a structural schematic diagram of a housing mounted on an outer wall of a fuel conveying channel;

FIG. 9 is an overall flow diagram;

FIG. 10 is a flow diagram of an intelligent anti-blocking function;

FIG. 11 is a flow diagram of an ignition mode; and

FIG. 12 is a schematic diagram of an anti-extinction mode.

Reference numerals in the drawings: 1. grill body; 11. combustion chamber; 111. vent hole; 112. feed opening; 12. mounting space; 13. air port; 14. electronic ignition rod; 2. screw conveyor; 21. fuel conveying channel; 211. feed port; 212. discharge port; 213. through hole; 22. screw; 3. blower; 4. motor; 5. funnel; 6. humidity sensor; 7. hygroscopic material; 8. housing; 9. wall body; 91. outer wall; and 92. inner wall.

### DESCRIPTION OF THE EMBODIMENTS

The technical solutions in the embodiments of the present invention will be clearly and completely described below in conjunction with the accompanying drawings in the embodiments of the present invention. Obviously, the embodiments described are only part but not all of the embodiments of the present invention. All other embodiments obtained by those of ordinary skill in the art based on the embodiments of the present invention fall within the scope of the present invention.

### Embodiment I

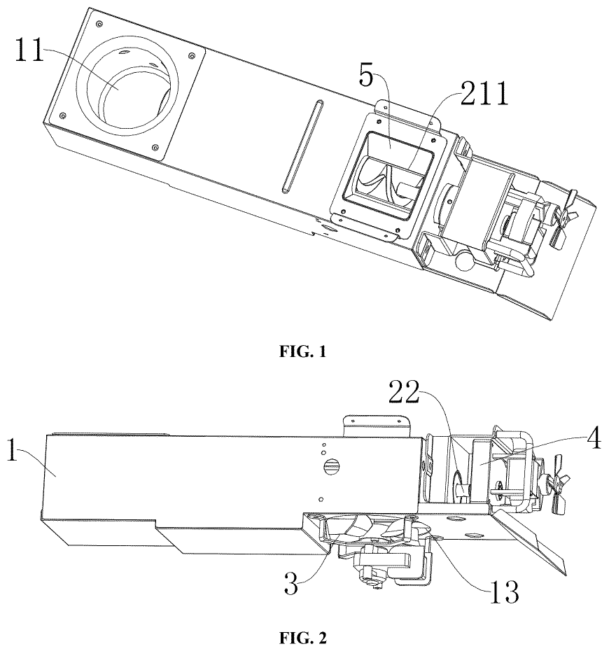

As shown in FIGS. 1-3 and 8, a feeding system of a pellet grill according to the present embodiment includes a screw conveyor 2, a humidity sensor 6 and a controller, and the humidity sensor 6 is generally a low-cost humidity-sensitive resistor, thus reducing later production cost and maintenance costs of the pellet grill.

The screw conveyor 2 includes a fuel conveying channel 21, a screw 22 located in the fuel conveying channel 21 and a rotary drive device for driving the screw 22 to rotate; a discharge port 212 of the fuel conveying channel 21 is connected with a feed opening 112 of a combustion chamber 11; the rotary drive device drives the screw 22 to rotate so as to convey a pellet fuel entering from the feed port 211 of the fuel conveying channel 21 to the discharge port 212 thereof and into the combustion chamber 11; the humidity sensor 6 is arranged on a wall body 9 of the fuel conveying channel 21; the rotary drive device includes a motor 4; a rotating shaft of the motor 4 is connected with one end of the screw 22 close to the feed port 211 of the fuel conveying channel 21, or the rotating shaft of the motor 4 is drivingly connected with one end of the screw 22 close to the feed port 211 of the fuel conveying channel 21 by a transmission mechanism, and the motor 4 and the humidity sensor 6 are respectively connected with and controlled by the controller; and the controller is composed of a MCU chip in which a program for controlling the motor 4 and the humidity sensor 6 is built, and the motor 4 drives the screw 22 to rotate so that the pellet fuel in the fuel conveying channel 21 is conveyed to the feed port 212 or the pellet fuel is returned to the feed port 211.

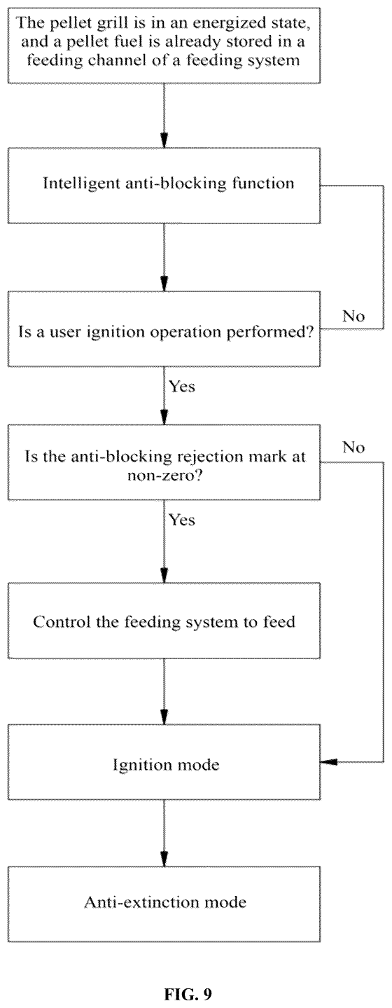

Specifically, the wall body 9 of the fuel conveying channel 21 has an outer wall 91 and a through hole 213, a sensing portion of the humidity sensor 6 is located on the outer wall 91, the sensing portion of the humidity sensor 6 is arranged positionally corresponding to the through hole 213, a hygroscopic material 7 is provided between the outer wall 91 and the sensing portion of the humidity sensor 6, the hygroscopic material 7 is generally polyamide fiber, upper and lower sides of the hygroscopic material 7 respectively fit with the outer wall 91 and the sensing portion of the humidity sensor 6, and the hygroscopic material 7 covers the through hole 213. As shown in FIG. 8, the humidity sensor 6 is fixed to the outer wall 91 by a housing 8, and the housing 8 is fixed to the outer wall 91 by bolts or welding.

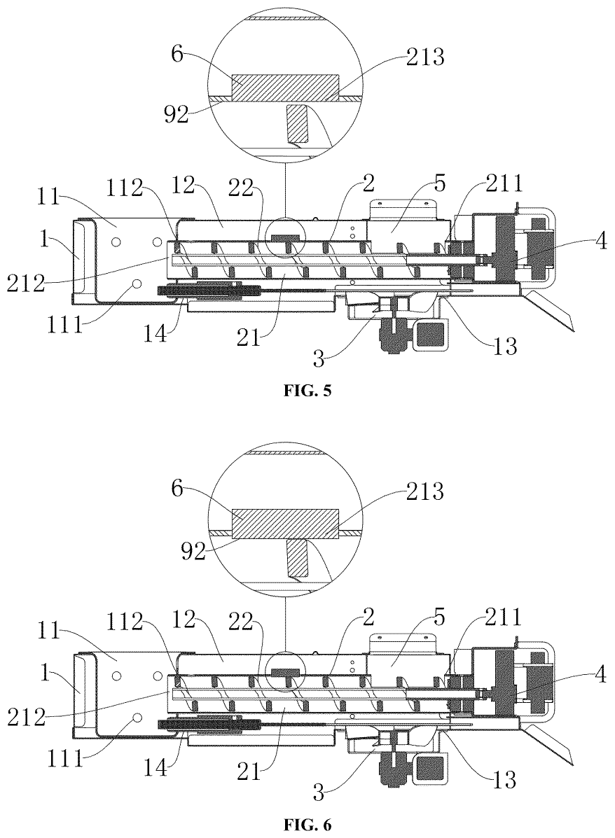

As shown in FIGS. 1, 2 and 4-6, the wall body 9 of the fuel conveying channel 21 has an inner wall 92 and a through hole 213, and the humidity sensor 6 is at least partially embedded in the through hole 213 so that the sensing portion of the humidity sensor 6 is flush with the inner wall 92, or the sensing portion of the humidity sensor 6 protrudes from the inner wall 92, or the sensing portion of the humidity sensor 6 is located in the through hole 213, and no hygroscopic material 7 is required in this solution.

Preferably, the humidity sensor 6 is located in a region between the feed port 211 and the discharge port 212 on the fuel conveying channel 21, and the humidity sensor 6 is fixed to an upper outer wall 91 or a lower outer wall 91 in the region by the housing 8. Correspondingly, a through hole 213 is formed on the wall body 9 of the fuel conveying channel 21 in the region between the feed port 211 and the discharge port 212 thereof, and the through hole 213 is located on an upper side or a lower side of the region so that the humidity sensor 6 and the through hole 213 positionally correspond to each other after the humidity sensor is fixed, and a plurality of through holes 213 may be arranged, or

The humidity sensor 6 is located in a region of the feed port 211 on the fuel conveying channel 21, and the humidity sensor 6 is fixed to an upper outer wall 91 or a lower outer wall 91 in the region by the housing 8. Correspondingly, a through hole 213 is formed on the wall body 9 of the fuel conveying channel 21 in the region of the feed port 211 thereof, and the through hole 213 is located on an upper side or a lower side of the region. Therefore, the humidity sensor 6 and the through hole 213 positionally correspond to each other after the humidity sensor is fixed, and a plurality of through holes 213 may be arranged.

Based on the above structure, humidity in the fuel conveying channel 21 is detected by the humidity sensor 6, and when the controller determines that a humidity value fed back by the humidity sensor 6 exceeds a threshold value preset by the controller, the controller controls the motor 4 to rotate so as to drive the screw 22 to reverse, so that the pellet fuel in the fuel conveying channel 21 is returned to the feed port 211, and all wetted pellet fuel is returned to the feed port 211 under continuous operation.

In the present embodiment, a feeding funnel 5 is connected to the feed port 211 of the fuel conveying channel 21, and is located at one end of the fuel conveying channel 21 close to the rotary drive device; the funnel 5 is arranged so that the pellet fuel in a bin enter the fuel conveying channel 21 during the process of conveying the pellet fuel to the combustion chamber 11, and the feed port 211 and the discharge port 212 on the fuel conveying channel 21 are arranged far away from each other, so that the fuel conveying channel 21 has a material storage function, and allows the combustion chamber 11 to burn the fuel therein for a period of time even when the bin has no fuel.

A lower side of the humidity sensor 6 serves as the sensing portion thereof, and the housing 8 can be welted or bolted to the outer wall 92 for fixation.

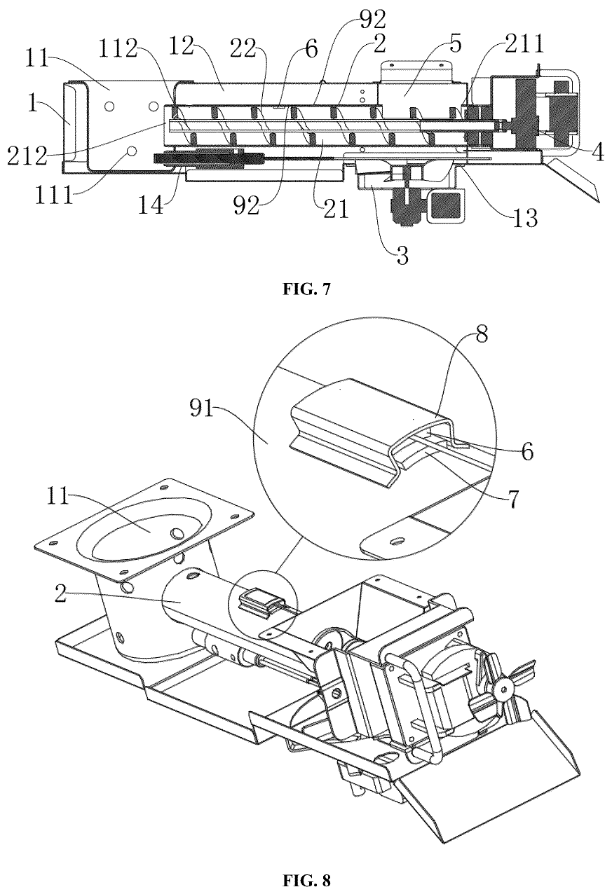

In another embodiment, as shown in FIG. 7, the wall body 9 of the fuel conveying channel 21 has an inner wall 92; and the humidity sensor 6 is mounted on the inner wall 92 and is in direct contact with the pellet fuel in the fuel conveying channel 21, and is configured to sense the humidity of the fuel. Here, the humidity sensor 6 is located in a region between the feed port 211 and the discharge port 212 on the fuel conveying channel 21, and the humidity sensor 6 is fixed to an upper inner wall 92 or a lower inner wall 92 in the region by a fastener, or the humidity sensor 6 is located in a region of the feed port 211 on the fuel conveying channel 21, and the humidity sensor 6 is fixed to an upper inner wall 92 or a lower inner wall 92 in the region by a fastener which is a bolt.

The above feeding system is mounted in a grill body 1 of the pellet grill. Specifically as shown in FIGS. 1-7, the grill body 1 of the pellet grill includes a combustion chamber 11 for pellet combustion, and the grill body 1 is of a rectangular parallelepiped structure; a screw conveyor 2 and an electronic ignition rod 14 are provided in a mounting space 12 of the grill body 1, an ignition end of the electronic ignition rod 14 is located in the combustion chamber 11, a vent hole 111 in communication with the mounting space 12 of the grill body 1 is provided on the combustion chamber 11, an air port 13 is provided on the grill body 1, and a blower 3 is mounted at the air port 13; and air blown out by the blower 3 during operation enters the combustion chamber 11 through the vent hole 111 to provide sufficient oxygen to the combustion chamber 11, playing a role in supporting combustion.

### Embodiment II

As shown in FIG. 9, a humidity detection-based pellet grill control method according to the present embodiment includes feeding a pellet fuel using the feeding system according to Embodiment I and sensing humidity after the feeding, and humidity sensing and detection steps after the feeding are as follows:

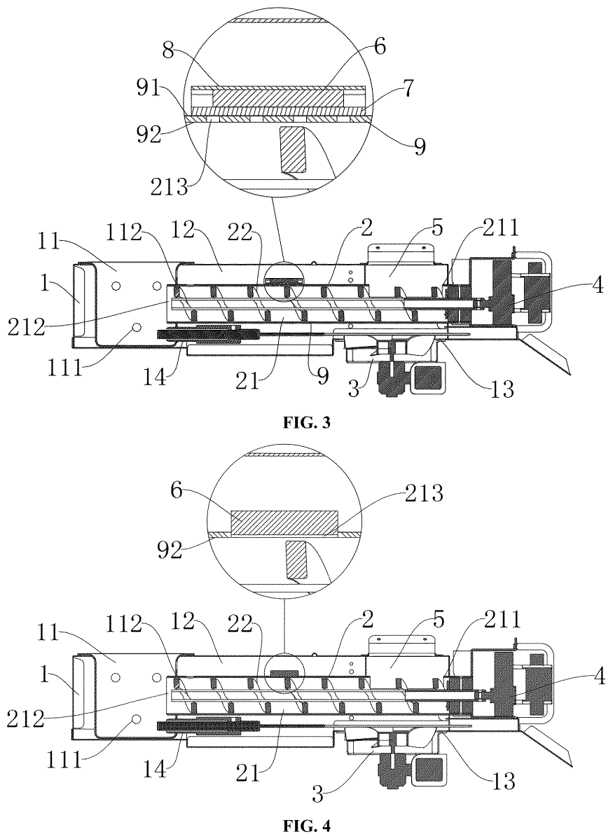

S1. The pellet grill is energized so that a feeding system thereof and a humidity sensor on the feeding system are in an energized state, where the humidity sensor is arranged on a fuel conveying channel 21 of the feeding system. Specifically, as shown in FIG. 3, the feeding system is a screw conveyor which includes a fuel conveying channel 21, a screw 22 provided in the fuel conveying channel 21 and a motor 4 for driving the screw to rotate, and a discharge port 212 of the fuel conveying channel 21 and an ignition head of the electronic ignition rod 14 are both located in a combustion chamber 11; a wall body 9 of the fuel conveying channel 21 has an outer wall 91 and a through hole 213; a sensing portion of the humidity sensor 6 is located on the outer wall 91; the sensing portion of the humidity sensor 6 is arranged positionally corresponding to the through hole 213; a hygroscopic material 7 is provided between the outer wall 91 and the sensing portion of the humidity sensor 6; the hygroscopic material 7 is generally polyamide fiber; upper and lower sides of the hygroscopic material 7 respectively fit with the outer wall 91 and the sensing portion of the humidity sensor 6; the hygroscopic material 7 covers the through hole 213; and the humidity sensor 6 is fixed to the outer wall 91 by a housing 8. Preferably, the humidity sensor 6 is located in a region between a feed port 211 and a discharge port 212 on the fuel conveying channel 21, and the humidity sensor 6 is fixed to an upper outer wall 91 or a lower outer wall 91 in the region by the housing 8. Correspondingly, a through hole 213 is formed on the wall body 9 of the fuel conveying channel 21 in the region between the feed port 211 and the discharge port 212 thereof, and the through hole 213 is located on an upper side or a lower side of the region so that the humidity sensor 6 and the through hole 213 positionally correspond to each other after the humidity sensor is fixed, and a plurality of through holes 213 may be arranged, where the screw conveyor 2 and the combustion chamber 11 are both located in a grill body 1, a vent hole 111 on the combustion chamber 11 is communicated with a cavity of the grill body 1, and a fan is mounted at an air port 13 of the grill body 1, or as shown in FIGS. 4, 5 and 6, the sensing portion of the humidity sensor 6 is directly embedded in the through hole 213 on the fuel conveying channel 21, or as shown in FIG. 7, the sensing portion of the humidity sensor 6 is directly embedded on an inner wall 92 of the fuel conveying channel 21.

S2. The humidity sensor 6 is used to continuously monitor humidity of the fuel conveying channel 21 of the feeding system in which a pellet fuel has been stored, so that a controller determines humidity level of a space environment or the pellet fuel in the fuel conveying channel 21, where the controller is a MCU chip in which a program for determining humidity is built.

If the space environment or the pellet fuel in the fuel conveying channel 21 is determined to have high humidity, the controller of the pellet grill controls the feeding system to enter a rejection mode (a rejection mode in intelligent anti-blocking) of returning the pellet fuel to the feed port 211 of the feeding system, or controls the pellet grill to enter a drying and ignition mode or controls the pellet grill to enter an anti-extinction mode; where the rejection mode can cause the motor 4 driving the screw 22 to reverse and drive the screw 22 to reverse so as to return the moist pellet fuel in the fuel conveying channel 21 to the feed port 211 thereof, and prevent the moist pellet fuel from drying again and clumping, which may cause blockage of the fuel conveying channel 21; the drying and ignition mode enables the moist pellet fuel to be conveyed into the combustion chamber 11 and then to be dried and ignited; and the anti-extinction mode is such that normal combustion flames in the combustion chamber 11 will not extinguish due to subsequently conveyed moist fuel.

If the space environment or the pellet fuel in the fuel conveying channel 21 is determined to have low humidity, the controller of the pellet grill controls the feeding system of the pellet grill to enter a feedable mode in which the pellet fuel can be conveyed to the combustion chamber 11 as long as the user uses the pellet grill.

Further, the humidity sensor 6 is a humidity-sensitive resistor, where the higher the humidity, the smaller the resistance value, and the lower the humidity, the larger the resistance value. Therefore, the humidity level of the space environment or the pellet fuel currently in the fuel conveying channel 21 is determined according to the resistance value of the humidity-sensitive resistor. Specifically, if the resistance value of the humidity-sensitive resistor is less than a preset resistance value, the controller of the pellet grill determines that the space environment or the pellet fuel currently in the fuel conveying channel 21 has high humidity; and if the resistance value of the humidity sensitive resistor is greater than the preset resistance value, the controller of the pellet grill determines that the space environment or the pellet fuel in currently the fuel conveying channel 21 has low humidity.

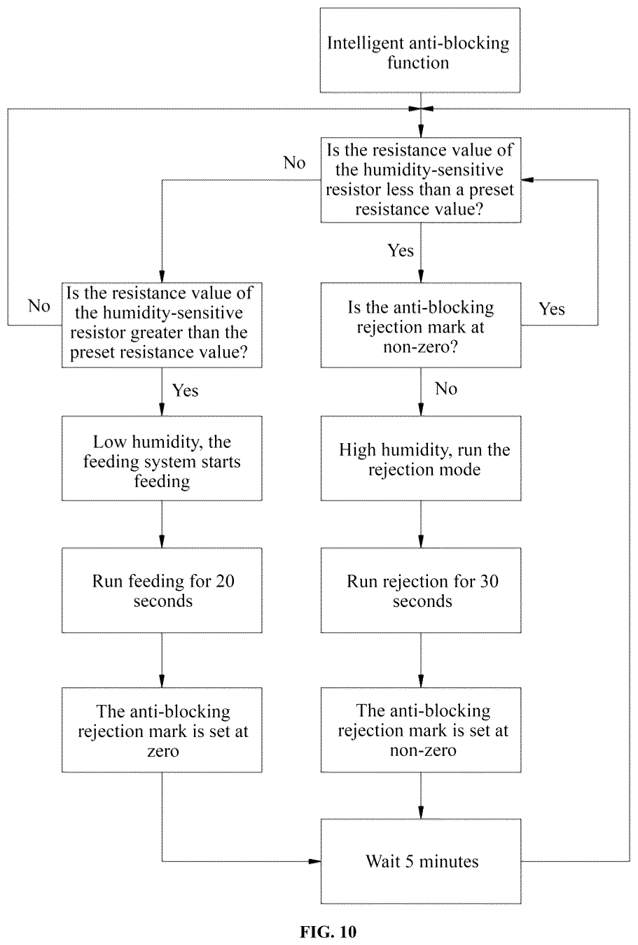

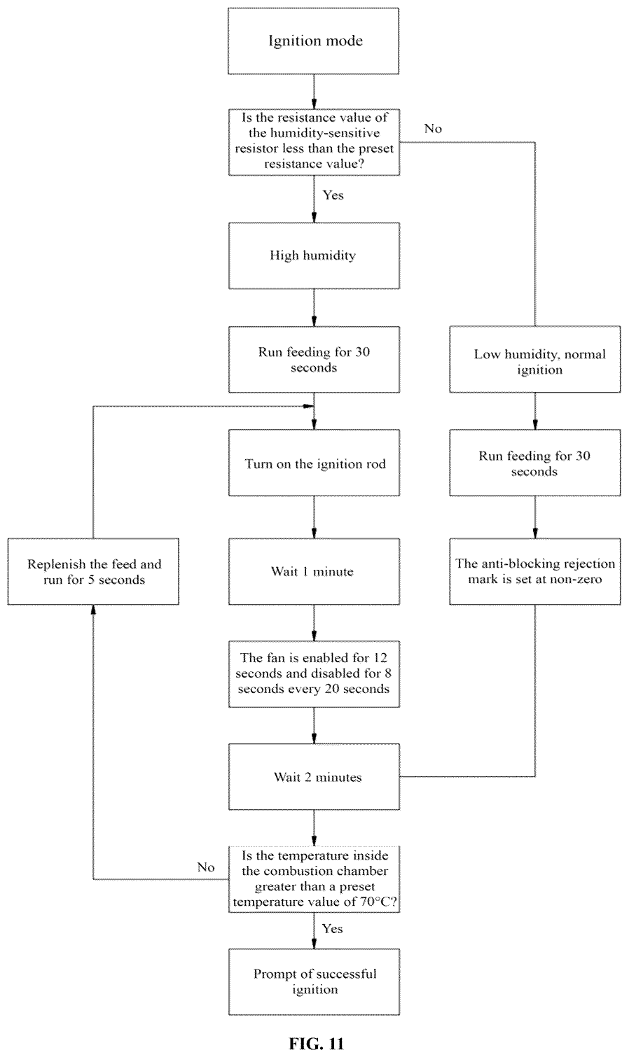

As shown in FIG. 10, on the basis of the above monitoring and determination, the pellet grill enters an intelligent anti-blocking function, and in the intelligent anti-blocking function, when the resistance value of the humidity-sensitive resistor is detected to be less than the preset resistance value, the controller determines and recognizes whether an anti-blocking rejection mark is at non-zero which is generally represented by “1” so as to recognize the anti-blocking rejection mark before entering the rejection mode, so as to know whether rejection has been carried out in the feeding system and avoid repeated rejection operations. Here, the specific method for determining the anti-blocking rejection mark is as follows: if the rejection mark is at non-zero, the humidity is monitored again; and if the rejection mark is at zero, the feeding system enters the rejection mode according to the high humidity, and the zero is generally represented by “0”.

Preferably, in the rejection mode, the controller controls the feeding system to perform rejection for a predetermined time, where the predetermined time for rejection is 30 seconds; after the rejection time has elapsed, the rejection mark is set at non-zero which is generally represented by “1”; at this time, the pellet grill enters a waiting time which is generally 5 minutes; and after the waiting time has elapsed, the humidity is monitored again. This mode allows to record that rejection has been performed before ignition to avoid repeated rejections when used again.

When the resistance value of the humidity-sensitive resistor is detected to be greater than the preset resistance value, the controller controls the feeding system to perform feeding for a predetermined time of the feedable mode, where the predetermined time for feeding is 20 seconds; after the feeding time has elapsed, the rejection mark is set at zero which is generally represented by “0”; the pellet grill enters a waiting time which is generally 5 minutes; and after the waiting time has elapsed, the humidity is monitored again. This mode allows to record that no rejection is performed before ignition, thus the feeding system can be controlled to perform rejection when the high humidity is detected before ignition.

S3. It is determined whether to perform a user ignition operation. At this time, the use may check the condition of the pellet fuel at the feed port 211, or check the condition at the feed port 211 before the pellet grill is energized, and if the pellet fuel is found to be dry and lump, manual cleaning is performed; where the determination of the user ignition operation is that the controller monitors whether the electronic ignition rod 14 performs ignition operation, and records operation of the electronic ignition rod 14, so that the controller can perform query and determination during subsequent operation.

If the user ignition operation is not performed, the humidity is monitored again, and the intelligent anti-blocking function is run.

If the user ignition operation is performed, it is determined whether the anti-blocking rejection mark is at non-zero. If the anti-blocking rejection mark is at non-zero which is generally represented by “1”, rejection has been performed before the user ignition operation so as to control the feeding system to feed for a preset time, the pellet grill enters an ignition mode after the feeding is completed, and the feeding time is set according to the required flame. If the anti-blocking rejection mark is at zero which is represented by “0”, rejection is not performed before the user ignition operation, and the pellet grill directly enters the ignition mode after the mark recognition.

Here, as shown in FIG. 11, the ignition mode includes the drying and ignition mode and a normal ignition mode.

The pellet grill enters the drying and ignition mode when the resistance value of the humidity-sensitive resistor is less than the preset resistance value and the space environment or the pellet fuel currently in the fuel conveying channel 21 is determined to have high humidity. After the pellet grill enters the drying and ignition mode, the controller controls the feeding system to perform feeding for a predetermined time to convey the pellet fuel into the combustion chamber 11, where the predetermined time for feeding is 30 seconds; after the feeding time has elapsed, the ignition rod in the combustion chamber 11 is turned on, and the ignition rod performs ignition for a predetermined time to dry the moist pellet fuel, where the predetermined operation time of the ignition rod is 1 minute, while the fan provides air and oxygen to the combustion chamber 11 in a continuous and intermittent operation mode and then enters a waiting period with a predetermined time, where the continuous and intermittent operation mode is that the fan is enabled for 12 seconds and disabled for 8 seconds every 20 seconds, and the predetermined time of the waiting period is 2 minutes; and after the waiting period ends, a temperature of the combustion chamber 11 is detected to determine whether the temperature is greater than a preset temperature value which is 70° C. so as to determine whether the ignition is successful. This mode can ensure that the moist pellet fuel in the combustion chamber 11 can be ignited, so as to solve the problem of difficult ignition in the prior art pellet grills.

The successful ignition is determined as follows: if the temperature of the combustion chamber 11 is greater than the preset temperature value, the ignition is successful; and if the temperature of the combustion chamber 11 is less than the preset temperature value, the controller controls the feeding system to perform feeding for a predetermined time to convey the pellet fuel into the combustion chamber 11 again so as to replenish the combustion chamber 11 with the dried pellet fuel, where the predetermined time for feeding is 5 seconds, and then the drying and ignition mode is rerun until a prompt of successful ignition is displayed. This mode enables the user to intuitively observe whether the ignition is successful in the drying and ignition mode, where the preset temperature value is 70° C.

The pellet grill enters the normal ignition mode when the resistance value of the humidity-sensitive resistor is greater than the preset resistance value and the space environment or the pellet fuel currently in the fuel conveying channel 21 is determined to have low humidity. After the pellet grill enters the normal ignition mode, the controller controls the feeding system to perform feeding for a predetermined time to convey the pellet fuel into the combustion chamber 11, where the predetermined time for feeding is 30 seconds, after the feeding time has elapsed, the electronic ignition rod 14 in the combustion chamber 11 is turned on, while the fan provides air and oxygen to the combustion chamber 11 in a continuous and intermittent operation mode and then enters a waiting period with a predetermined time, where the continuous and intermittent operation mode is that the fan is enabled for 12 seconds and disabled for 8 seconds every 20 seconds, and the predetermined time of the waiting period is 2 minutes; and after the waiting period ends, the temperature of the combustion chamber 11 detected to determine whether the temperature is greater than the preset temperature value so as to determine whether the ignition is successful.

The successful ignition is determined as follows: if the temperature of the combustion chamber 11 is greater than the preset temperature value, the ignition is successful; and if the temperature of the combustion chamber 11 is less than the preset temperature value, the controller controls the feeding system to perform feeding for a predetermined time to convey the pellet fuel into the combustion chamber 11 again, where the predetermined time for feeding is 5 seconds, and then the drying and ignition mode is rerun until a prompt of successful ignition is displayed. This mode enables the user to intuitively observe whether the ignition is successful in the normal ignition mode, where the preset temperature value is 70° C.

S4. After the ignition is successful, it is determined whether the resistance value of the humidity-sensitive resistor is less than the preset resistance value, and a specific determination method is as follows:

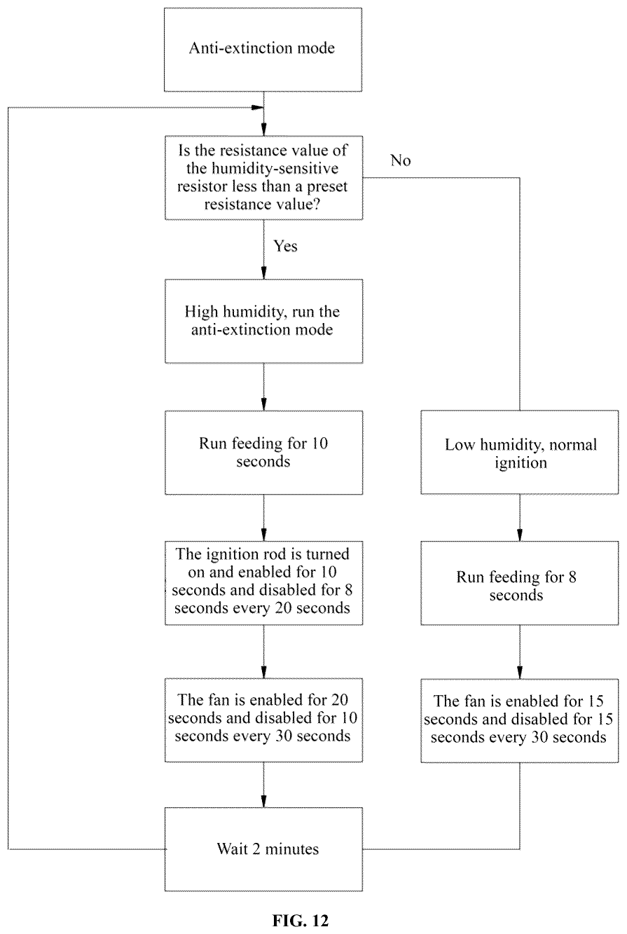

If the resistance value of the humidity-sensitive resistor is determined to be less than the preset resistance value after the ignition is successful, the space environment or the pellet fuel currently in the fuel conveying channel 21 is determined to have high humidity, and the pellet grill directly enters the anti-extinction mode. As shown in FIG. 12, after the pellet grill enters the anti-extinction mode, the controller controls the feeding system to perform feeding for a predetermined time to convey the pellet fuel into the combustion chamber 11, where the predetermined time for feeding is 10 seconds; after the feeding time has elapsed, the ignition rod in the combustion chamber 11 is turned on and performs ignition in a continuous and intermittent operation mode, where the continuous and intermittent operation mode of the ignition rod is that the ignition rod is enabled for 10 seconds and disabled for 10 seconds every 20 seconds, while the fan provides air and oxygen to the combustion chamber 11 in a continuous and intermittent operation mode and then enters a waiting period with a predetermined time, where the continuous and intermittent operation mode of the fan is that the fan is enabled for 20 seconds and disabled for 10 seconds every 30 seconds, the predetermined time of the waiting period is 5 minutes; and after the waiting period ends, the humidity is monitored again.

If the resistance value of the humidity-sensitive resistor is determined to be greater than the preset resistance value after the ignition is successful, the space environment or the pellet fuel currently in the fuel conveying channel 21 is determined to have low humidity, and the pellet grill directly enters the normal operation mode, and in the mode, the controller controls the feeding system to perform feeding for a predetermined time to convey the pellet fuel into the combustion chamber 11, where the predetermined time for feeding is 8 seconds, while the fan provides air and oxygen to the combustion chamber 11 in a continuous and intermittent operation mode and then enters a waiting period with a predetermined time, where the continuous and intermittent operation mode of the fan is that the fan is enabled for 15 seconds and disabled for 15 seconds every 30 seconds, and the predetermined time of the waiting period is 5 minutes; and after the waiting period ends, the humidity is monitored again.

Here, in step S4, after the ignition is successful, it is possible to avoid extinction due to subsequently conveyed moist pellet fuel, thereby maintaining the original combustion efficiency and temperature.

Finally, the temperature inside the combustion chamber 11 is collected by a temperature sensor provided in the combustion chamber 11 and fed back to the controller.

What is claimed is:

1. A humidity detection-based pellet grill control method, comprising the following steps:
S1. energizing a pellet grill so that a feeding system thereof and a humidity sensor provided on the feeding system are in an energized state; and
S2. using the humidity sensor to continuously monitor humidity of a fuel conveying channel of the feeding system in which a pellet fuel has been stored, so that a controller determines humidity level of a space environment or the pellet fuel in the fuel conveying channel;
if the space environment or the pellet fuel in the fuel conveying channel is determined to have high humidity, controlling, by the controller of the pellet grill, the feeding system to enter a rejection mode of returning the pellet fuel to a feed port of the feeding system, or the pellet grill to enter a drying and ignition mode or the pellet grill to enter an anti-extinction mode; and
if the space environment or the pellet fuel in the fuel conveying channel is determined to have low humidity, controlling, by the controller, the feeding system of the pellet grill to enter a feedable mode.

2. The humidity detection-based pellet grill control method according to claim 1, wherein the humidity sensor is a humidity-sensitive resistor, and the humidity level of the space environment or the pellet fuel currently in the fuel conveying channel is determined according to a resistance value of the humidity-sensitive resistor;
if the resistance value of the humidity-sensitive resistor is less than a preset resistance value, the controller of the pellet grill determines that the space environment or the pellet fuel currently in the fuel conveying channel has high humidity; and
if the resistance value of the humidity-sensitive resistor is greater than the preset resistance value, the controller of the pellet grill determines that the space environment or the pellet fuel currently in the fuel conveying channel has low humidity.

3. The humidity detection-based pellet grill control method according to claim 2, wherein an anti-blocking rejection mark recognition step is further provided before entering the rejection mode, and the step comprises the following steps:
when the resistance value of the humidity-sensitive resistor is less than the preset resistance value, determining and recognizing, by the controller, whether the anti-blocking rejection mark is at non-zero;
if the anti-blocking rejection mark is at non-zero, returning to monitor the humidity again; and
if the anti-blocking rejection mark is at zero, entering the rejection mode according to the high humidity.

4. The humidity detection-based pellet grill control method according to claim 3, wherein the controller controls the feeding system to perform rejection for a predetermined time in the rejection mode, and sets the rejection mark at non-zero after a rejection time has elapsed.

5. The humidity detection-based pellet grill control method according to claim 2, wherein when the resistance value of the humidity-sensitive resistor is greater than the preset resistance value, the controller controls the feeding system to perform feeding for a predetermined time in the feedable mode, and sets the rejection mark at zero after a feeding time has elapsed.

6. The humidity detection-based pellet grill control method according to claim 2, further comprising:
S3. determining whether to perform a user ignition operation;
if the user ignition operation is not performed, monitoring the humidity again; and
if the user ignition operation is performed, determining whether the anti-blocking rejection mark is at non-zero; if the anti-blocking rejection mark is at non-zero, rejection has been performed before the user ignition operation so as to control the feeding system to feed for a preset time, so that the pellet grill enters the ignition mode after feeding is completed; and if the anti-blocking rejection mark is at zero, rejection is not performed before the user ignition operation, and the pellet grill directly enters the ignition mode after the mark recognition.

7. The humidity detection-based pellet grill control method according to claim 6, wherein the ignition mode comprises:
the drying and ignition mode, the pellet grill enters the drying and ignition mode when the resistance value of the humidity-sensitive resistor is less than the preset resistance value and the space environment or the pellet fuel currently in the fuel conveying channel is determined to have high humidity;
after the pellet grill enters the drying and ignition mode, the controller controls the feeding system to perform feeding for a predetermined time to convey the pellet fuel into a combustion chamber, after the feeding time has elapsed, an ignition rod in the combustion chamber is turned on, the ignition rod performs an ignition operation for a predetermined time to dry moisture pellet fuel, while a fan provides air and oxygen to the combustion chamber in a continuous and intermittent operation mode and then enters a waiting period with a predetermined time; and after the waiting period ends, a temperature of the combustion chamber is detected to determine whether the temperature is greater than a preset temperature value;
if the temperature of the combustion chamber is greater than the preset temperature value, ignition is successful; and
if the temperature of the combustion chamber is less than the preset temperature value, the controller controls the feeding system to perform feeding for a predetermined time to convey the pellet fuel into the combustion chamber again, and then rerun the drying and ignition mode until the ignition is successful.

8. The humidity detection-based pellet grill control method according to claim 7, wherein the ignition mode further comprises:
a normal ignition mode, the pellet grill enters the normal ignition mode when the resistance value of the humidity-sensitive resistor is greater than the preset resistance value and the space environment or the pellet fuel currently in the fuel conveying channel is determined to have low humidity;
after the pellet grill enters the normal ignition mode, the controller controls the feeding system to perform feeding for a predetermined time to convey the pellet fuel into the combustion chamber, after the feeding time has elapsed, the ignition rod in the combustion chamber is turned on, while the fan provides air and oxygen to the combustion chamber in a continuous and intermittent operation mode and then enters a waiting period with a predetermined time; and after the waiting period ends, the temperature of the combustion chamber is detected to determine whether the temperature is greater than the preset temperature value;
if the temperature of the combustion chamber is greater than the preset temperature value, ignition is successful; and
if the temperature of the combustion chamber is less than the preset temperature value, the controller controls the feeding system to perform feeding for a predetermined time to convey the pellet fuel into the combustion chamber again, and then rerun the drying and ignition mode until the ignition is successful.

9. The humidity detection-based pellet grill control method according to claim 7, further comprising:
S4. determining whether the resistance value of the humidity-sensitive resistor is less than the preset resistance value after the ignition is successful;
if the resistance value of the humidity-sensitive resistor is determined to be less than the preset resistance value after the ignition is successful, the space environment or the pellet fuel currently in the fuel conveying channel is determined to have high humidity, and the pellet grill directly enters the anti-extinction mode; and
if the resistance value of the humidity-sensitive resistor is determined to be greater than the preset resistance value after the ignition is successful, the space environment or the pellet fuel currently in the fuel conveying channel is determined to have low humidity, and the pellet grill directly enters the normal operation mode, and in the mode, the controller controls the feeding system to perform feeding for a predetermined time to convey the pellet fuel into the combustion chamber, while the fan provides air and oxygen to the combustion chamber in a continuous and intermittent operation mode and then enters a waiting period with a predetermined time; and after the waiting period ends, the humidity is monitored again.

10. The humidity detection-based pellet grill control method according to claim 9, wherein after the pellet grill enters the anti-extinction mode, the controller controls the feeding system to perform feeding for a predetermined time to feed the pellet fuel into the combustion chamber, after the feeding time has elapsed, the ignition rod in the combustion chamber is turned on and performs ignition in a continuous and intermittent manner, while the fan provides air and oxygen to the combustion chamber in a continuous and intermittent operation mode and then enters a waiting period with a predetermined time, and after the waiting period is ends, the humidity is monitored again.

11. A feeding system of a pellet grill, comprising:
a screw conveyor comprising a fuel conveying channel, a screw located in the fuel conveying channel and a rotary drive device for driving the screw to rotate, a discharge port of the fuel conveying channel being connected with a feed opening of a combustion chamber;
a humidity sensor provided on a wall body of the fuel conveying channel; and
a controller, the rotary drive device and the humidity sensor being respectively connected with and controlled by the controller.

12. The feeding system of the pellet grill according to claim 11, wherein the wall body of the fuel conveying channel has an outer wall and a through hole, a sensing portion of the humidity sensor is located on the outer wall, and the sensing portion of the humidity sensor is arranged positionally corresponding to the through hole.

13. The feeding system of the pellet grill according to claim 12, wherein a hygroscopic material is provided between the outer wall and the sensing portion of the humidity sensor, and upper and lower sides of the hygroscopic material respectively fit with the outer wall and the sensing portion of the humidity sensor, and the conveying channel material covers the through hole.

14. The feeding system of the pellet grill according to claim 11, wherein the wall body of the fuel conveying channel has an inner wall and a through hole, and the humidity sensor is at least partially embedded in the through hole so that the sensing portion of the humidity sensor is flush with the inner wall, or the sensing portion of the humidity sensor protrudes from the inner wall, or the sensing portion of the humidity sensor is located in the through hole.

15. The feeding system of the pellet grill according to claim 11, wherein the wall body of the fuel conveying channel has an inner wall, and the humidity sensor is mounted on the inner wall and in direct contact with a pellet fuel in the fuel conveying channel.

16. The feeding system of the pellet grill according to claim 11, wherein the humidity sensor is located in a region between a feed port and the discharge port on the fuel conveying channel, or
the humidity sensor is located in a feed port region on the fuel conveying channel.

17. The feeding system of the pellet grill according to claim 16, wherein the humidity sensor is located on an upper side or a lower side of the fuel conveying channel.

18. The feeding system of the pellet grill according to claim 13, wherein the humidity sensor is fixed to the outer wall by a housing, and the hygroscopic material is mounted in the housing.
